(19) United States
(12) Patent Application Publication
(10) Pub. No.: US 2013/0120137 A1
(43) Pub. Date: May 16, 2013

(54) PERSON-GUIDING SYSTEM FOR EVACUATING A BUILDING OR A BUILDING SECTION

(71) Applicant: Philip Lehmann, Witten (DE)

(72) Inventor: Philip Lehmann, Witten (DE)

(73) Assignee: Crosscan GMBH, Witten (DE)

(21) Appl. No.: 13/261,576

(22) PCT Filed: Apr. 13, 2011
(86) PCT No.: PCT/DE2011/000399

§ 371 Date: Jan. 28, 2013

(30) Foreign Application Priority Data
Aug. 12, 2010 (DE) 102010034072.3

(51) Int. Cl. G08B 21/02

(52) U.S. Cl. CPC G08B 21/02
USPC 340/524

(57) ABSTRACT

The invention relates to a system and a method for evacuating a building or a building section. The system comprises at least one building-mounted sensor unit including a sensor and a unit for determining at least the location of a danger source within the building or the building section. The sensor unit is configured to periodically or quasi-continually determine at least one characteristic feature of a person flow within the building or the building section. Furthermore, the sensor unit and the unit for determining at least one danger source are communicatively connected to an evaluation and control unit which is configured to issue a control command to a unit for regulating the person flow depending on the at least one characteristic feature determined by the sensor unit and at least the location of the danger source.

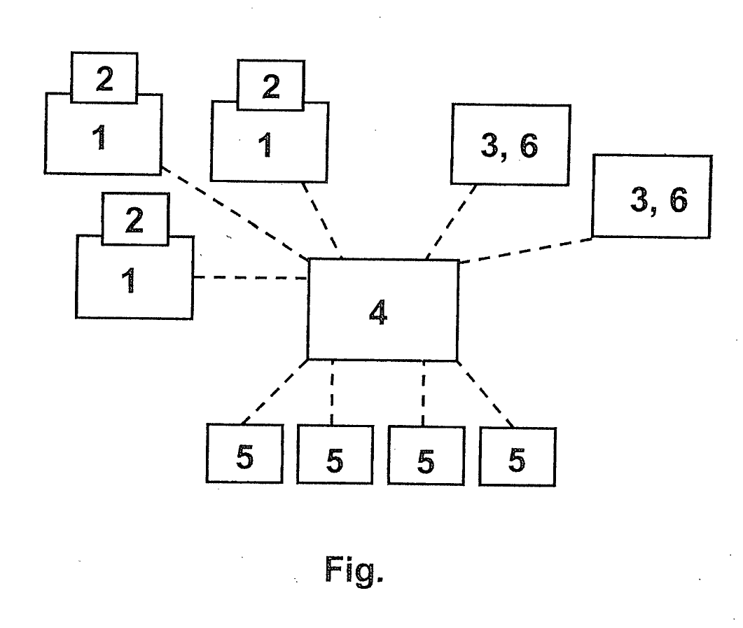

The invention relates to a person-guiding system and a corresponding method for evacuating a building or a building section.

A variety of person-guiding and emergency alert systems is known from the prior art. Such emergency alert system include, for example, fire detectors which are attached, for example, on the ceiling of a room or building which is to be surveyed as a building-mounted system and which issue an acoustic alert signal as soon as a source of fire is identified by means of smoke development emerging thereof. Furthermore, decentralized systems are known wherein, as the result of a detected danger source, a corresponding alert indication is represented on a decentralized display or which is immediately transferred to a fire fighter team or to the fire department.

Further, person-guiding systems in form of display panels and the like are known which are intended to ensure a planned outward flow of persons within a building, either statically or depending on a localized danger source.

DE 295 14 339 U1 describes an electronic person-guiding system wherein information displayed on sign-boards may be continually adapted to the actual facts. An essential component of the described system is a central computer which is communicatively connected to the sign-boards distributed within the building and which analyzes person and/or service and/or spatial digital data and accordingly drives the sign-boards connected therewith for the purpose of displaying information.

A person-guiding system for a person transport system is known from DE 11 2004 002 865 T5 including a detection device for person trajectories assessing the direction of motion of persons within a room and which is communicatively connected to a data processing device which controls access areas to that room in response to the person motion detected by the detecting device of person trajectories.

DE 10 2004 057 000 B3 discloses a sensor controlled emergency and evacuation system for large objects wherein in an evacuation situation the person flow is determined by means of pressure sensors integrated into the floors. In this way, it is possible to determine the running direction of persons to be evacuated and to gain information, in which area of a building persons are present, to conclude about measures to give best assistance for them.

AT 502 163 A1 describes an evacuation system having rescue sign lamps and monitoring sensors, wherein signals from the monitoring sensors are assessed by an central computing system, whereupon the central computing system selectively unblocks or blocks escape routes by planned driving of building means and rescue sign lamps. It is further proposed that the rescue sign lamps include a control unit which can be coupled to a display and which is connected to the computing system via a network, which control unit is selectively connected to one or to at least two displays via an interface.

A sensor controlled emergency and evacuation system for large objects is known from DE 10 2005 055 164 A1, where sensors may be wireless detected by a detector central office and wherein a sensor is integrated into an identification card or of an authorization card which must be carried by the person for detecting and locating persons in the large object. The proposed system allows consideration of the location of an individual person during evacuation. It is disadvantageous that, to guarantee a reliable functioning of the evacuation system, it is always required that all people in the large object are provided with a relevant card which they always carry with them.

Finally, DE 196 44 127 B1 describes an evacuation system wherein an escape route sign posting is embodied variably and adaptable to the relevant dangerous situation. Further, detectors for object monitoring and automatic danger recognition are provided which are communicatively connected to a central detection unit, so that, depending on a risk potential, the variable escape route sign posting can be controlled via the central detection unit. Further, it is proposed to vary control of the variable escape route sign posting dependent on a detected average likelihood of persons, depending on the day of time, being in the vicinity of a dangerous section, in particular in a scene of fire. It is, however, disadvantages that no actual numbers of persons are considered, but merely averaged, estimated or other values derived from experience are taken into consideration.

Evacuation situations in large object produce person flows which are generally difficult to predict which, caused by panic of escaping persons, comprise abnormalities in their flow behavior and thus may be sometimes give a chaotic impression. A result is then that for effective evacuation the actual forming person flow must be considered in an evacuation situation.

It is the object of the invention to propose a person-guiding system of the generic type which does not comprise the disadvantage mentioned with respect to the prior art. In particular, the proposed person-guiding system should be work reliably, independent of the fact, that persons within a building carry an identity card, an authorization card or the like which may be read by a sensor. Finally, the person-guiding system to be proposed should allow that, for generating an individual evacuation concept, the person flows actually occurring in an evacuation situation are considered.

This object is solved by a system for evacuating a building or a building section of claim 1. A corresponding method is subject-matter of independent claim 6. Preferred embodiments are subject-matter of the dependent claims.

The system for evacuating a building or a building section according to the invention includes:
at least one building-mounted sensor unit including a sensor, the sensor unit being configured to periodically or quasi-continually determine at least one characteristic feature of a person flow within the building or the building section; and
at least one unit for determining at least the location of a danger source within the building or the building section;
   wherein the sensor unit and the unit for determining at least one danger source are communicatively connected to an evaluation and control unit which is configured to issue a control command to a unit for regulating the person flow depending on the at least one characteristic feature determined by the sensor unit and at least the location of the danger source.

According to a preferred embodiment, the sensor is designed to produce a three-dimensional mapping of the person flow. It is in particular preferred that such a 3D sensor is a stereo camera. It is appropriate to arrange the sensors and/or sensor units of the system according to the invention at essential way points of a building or a building section. At those points, they can, for example, be used to determine a velocity, a direction, a person density, a person number or a gradient of one of the previously mentioned characteristic features in the building section used for the determination or in the entire building. Essential way points are, for example, entrances and exits of rooms, intersections or constrictions of hallways. If, for example, a room possesses a defined entrance and a defined exit, it may be provided according to an embodiment to the invention that a sensor is respectively arranged both at the entrance and at the exit which counts persons entering the room or leaving the room, respectively. In this way, the actual number of persons in the respectively room may be derived by the evaluation and control unit. However, it is also conceivable that the sensors or sensor units themselves are designed to determine the number of persons present in a room or another characteristic feature. To achieve this, it may be appropriate to communicatively connect the sensors or sensor units, respectively. In another embodiment, it is provided that a single sensor or a single sensor unit, respectively, determines the persons leaving the room and entering the room. If such a sensor is arranged at the only entrance into the room, a conclusion of a number or persons present in that room is possible only by that sensor. As already mentioned, determination of the number of persons is only one possible characteristic feature. Accordingly, it is also conceivable, that the sensors mentioned in the previous examples will not determine an actual number of persons, but a flow velocity, a flow direction, a person density or a respective gradient, respectively referring to a single person or a group of persons.

The use of 3D sensors, in particular stereo cameras, has the advantage that they allow a high precision imaging of three dimensional objects, such as persons. Thus, 3D sensors are in particular suitable for identification and classification of persons. Moreover, 3D sensors are insensitive to shadow effects or allow effectively distinction between object and shadow in a shadow situation.

Furthermore, the system for evacuating a building or a building section according to the invention comprises at least one unit for determining at least the location of a danger source within the building or the building section. Determination of the location of the danger source is merely minimum information which is transferred to the evaluation and control unit by the unit. According to the embodiment, it is also conceivable that the at least one unit for determining at least the location of a danger source undertakes a further qualification of the danger source further to the location of the danger source. For example, from the smoke development in a case of fire the extent of the source of fire, or from the gases produced thereby the hazard potential of a source of fire may be concluded, respectively. The present invention however; is not intended to be limited to systems for evacuation in the event of a fire. The unit for determining at least the location of a danger source may comprise all conceivable sensors and the like which are suitable for characterizing a danger in the broadest sense. For example, from measured values provided by a flow or water level sensor, it may be concluded that liquids, for example water, are unintentionally emerging.

It is essential for the invention that the sensor units are arranged stationary in buildings, however, determining the at least one characteristic feature of a person flow periodically or quasi-continuously. With the aid of the evaluation and control unit which communicatively connects to the sensor unit, it is possible to perform a real time analysis of person flows which are produced in the event of evacuation within a building or a building section and to develop an individual evacuation concept under consideration of the measuring results from the unit for determining at least the location of a danger source. Accordingly, the evaluation and control unit may output one or more control commands, one-time or periodically or quasi-continuously updated, to one or more units for regulating the person flow.

Also, the mentioned unit for regulating the person flow is not intended to be limited to any particular apparatus. Preferably, however, it includes visual or acoustical indication, for example display panels of an escape route, passenger transportation means or safety barriers which indications can be selectively activated.

In a preferred embodiment, the unit for determining at least the location of a danger source is a fire detector or a central fire alarm system and designed to determine a source of fire or the smoke concentration within the building or the building section.

In a particular embodiment, the sensor unit is configured to identify and/or to classify individual persons according to criteria which are predefined and can be detected by means of the sensor unit. It is, for example, conceivable that a rough identification of adults, children or injured persons is performed with the aid of the sensor unit. Persons which are injured or impaired in other ways may be identified because they move atypically, i.e. for example slower than the remaining person flow in average. Also from the direction of motion of individual persons in relation to the average direction of motion of the person flow, it may be concluded that persons who need help are present. In an embodiment, it is, for example, conceivable that the evaluation and control unit is configured to issue a respective warning to a rescue team as a result of an impaired person which has been identified. That warning may either be transferred to a decentralized rescue center or the like or output via the at least one unit for regulating the person flow.

Irrespectively, whether the unit for determining at least the location of a danger source has already communicated the presence thereof to the evaluation and control unit, it is possible, only with the aid of the sensor unit which is also communicatively connected to the evaluation and control unit to conclude a state of danger from a specific behavior of persons present in the building which has been determined by the sensor unit from at least detected characteristic feature. It is, for example, conceivable, that limiting values for the characteristic features of a person flow determined by the sensor unit are predefined, exceeding thereof being interpreted by the evaluation and control unit as an indication of a potential danger source. For example, a dangerous situation may be concluded from a characteristic velocity variation of the person flow or based on an increased gradient of one of the previously mentioned characteristic features. Conceivable criteria are, for example, an abrupt change of the velocity of a person flow or the number of persons present within a building or a building section. A particular characteristic indication of a resulting hazard potential may be seen in the fact that runways are more frequently used than in average. An embodiment of the invention determination of such an event is used as a trigger signal for activating the at least one unit for determining at least the location of a danger source within the building or the building section. That embodiment has in particular the advantage that false measurements of a unit for determining the location of a danger source do not lead to an undesired activation of the system and consequently evacuation of the building or building section. Otherwise, it is, for example, conceivable that responsive to a false alarm of the at least one unit for determining at least the location of a danger source the system according to the invention is activated and initiates the evacuation of the building or building section. False alarms of this type may, for example, be the result of that a fire detector reacts to cigarette smoke and transfers a relevant signal to the evaluation and control unit.

A method of evacuating a building or a building section according to the invention comprises the steps of:
determining at least one characteristic feature of a person flow Within a building or a building section;
determining at least the location of a danger source within the building or the building section;
outputting a control command to a unit for regulating the person flow, the control command being produced according to the at least one characteristic feature and at least the determined location of the danger source.

According to a preferred embodiment of the method according to the invention, determining of at least one characteristic feature of a person flow includes performing a net flow analysis wherein the characteristic feature is derived from a difference between a number of persons entering a building or a building section and a number of persons leaving a building or a building section.

In another embodiment, determining of at least one characteristic feature includes identifying and/or classifying of individual persons in the person flow by criteria which can be predefined. In particular, preferred is to emit an emergency signal in response to the result of the identification process and/or the classification process.

Advantageous embodiments of the invention are explained with the aid of the figure below. It shows a possible embodiment of the invention, wherein three stationary sensor units 1, respectively comprising a sensor 2, are communicatively connected to an evaluation and control unit 4. Likewise, two units 3 for determining at least the location of a danger source are communicatively connected to the evaluation and control unit 4. Likewise, evaluation and control unit 4 is communicatively connected to four units 5 for regulating a person flow. Those communicative connections are respectively illustrated by dotted lines. Presently, units 3 are embodied as fire detectors 6.

In the illustrated embodiment, sensor unit 1 may be arranged respectively on a floor of a building, for example, in the respective hallway of the floor. If the hallway is the only entrance to the relevant floor, sensor unit 1 or several thereof may be used to monitor how many persons are present on the relevant floor. The relevant sensor unit 1 transfers the respective measuring result to evaluation and control unit 4. This is done appropriately periodically or quasi-continuously. In this way, evaluation and control unit 4 is informed about variation of the number of persons on a relevant floor in order to conclude appropriate measures for regulating the person flow on the relevant floor.

It is essential for the invention that evaluation and control unit 4 selects the evacuation concept not only depending on the number of persons present on a relevant floor, but also considers the location of at least one danger source which is detected by at least one of units 3 and transferred to evaluation and control unit 4.

In the described embodiment, evaluation and control unit 4 would in an event of evacuation activate units 5 for regulating the person flow in a manner that the person flow is; for example, guided towards a stairwell which is remote from the danger source. Evaluation and control unit 4 will also consider predefined limiting conditions when determining the evacuation concept. Those limiting conditions may, for example, include an escape route provided in the building or an otherwise specified escape route. Evaluation and control unit 4 will also select the optimum escape route so that in view of the resulting person flow a sufficiently fast run-off of persons is possible. In this respect, evaluation and control unit 4 will provide more than one escape route depending on the detected number of persons and will activate units 5 for regulating the person flow, accordingly.

If at least one of units 3 detects a closed escape route and communicates this fact to the evaluation and control unit 4, it will determine an alternate escape route and respectively activate units 5 for regulating the person flow.

Evacuation of at least one building section being completed, evaluation and control unit 4 may initiate measures for fighting the danger source. In an event of fire, this may, for example, include activating an extinguishing system, such as a CO₂ extinguishing system. In this way it is possible to exclude endangering of persons still present within the building or the building section in an event of evacuation by untimely initiating measures for fighting the danger source.

If at least one of sensor units 1 has detected an impaired person or has determined a building section where still persons are present in spite of initiated evacuation, evaluation and control unit 4 may use this information to inform rescue workers accordingly or to control units 5 for regulating the person flow such that rescue workers are guided to the mentioned persons or building sections, respectively.

The features of the invention disclosed in the previous description, in the drawing and in the claims may be material for realizing the invention individually and in any combination.

1-10. (canceled)

11. A person-guiding system for evacuating a building or a building section, comprising
at least one building-mounted sensor unit including a sensor, the sensor unit being configured to periodically or quasi-continually determine at least one characteristic feature of a person flow within the building or the building section; and
at least one unit for determining at least the location of a danger source within the building or the building section;
wherein the sensor unit and the unit for determining at least one danger source are communicatively connected to an evaluation and control unit which is configured to issue a control command to a unit for regulating the person flow depending on the at least one characteristic feature determined by the sensor unit and at least the location of the danger source, and
wherein the sensor is designed to produce a three-dimensional mapping of the person flow.

12. The system of claim 11, wherein the unit for determining at least the location of a danger source is a fire detector or a central fire alarm system and configured to detect a source of fire and/or a smoke concentration within the building or the building section.

13. The system of claim 11, wherein the sensor unit is configured to identify and/or classify individual persons according to criteria which are predefined and can be detected by means of the sensor unit.

14. The system of claim 11, wherein the unit for regulating the person flow includes visual or acoustical indications of an escape route, passenger transportation means or safety barriers which indications can be selectively activated.

15. The system of claim 11, wherein the characteristic feature is a velocity, a direction, a density of persons, a number of persons, or a gradient of any of the afore-mentioned characteristic features of the building section or the entire building intended for the determination.

16. A method of evacuating a building or a building section, comprising the steps of:
determining at least one characteristic feature of a person flow within a building or a building section;
determining at least the location of a danger source within the building or the building section;
outputting a control command to a unit for regulating the person flow, the control command being produced according to the at least one characteristic feature and at least the determined location of the danger source, and
performing a three-dimensional mapping of the person flow with said sensor.

17. The method of claim 16, wherein the characteristic feature is a velocity, a direction, a density of persons, a number of persons, or a gradient of any of the afore-mentioned characteristic features of the building section or the entire building intended for the determination.

18. The method of claim 17, wherein determining of at least one characteristic feature of a person flow includes a net flow analysis wherein the characteristic feature is derived from a difference between a number of persons entering a building or a building section and a number of persons leaving a building or a building section.

19. The method of claim 16, wherein determining of at least one characteristic feature includes identifying and/or classifying of individual persons in the person flow by criteria which can be predefined.

20. The method of claim 19, wherein an emergency signal is emitted in response to the result of the identification process and/or the classification process.
